(19) United States
(12) Patent Application Publication
(10) Pub. No.: US 2025/0145077 A1
(43) Pub. Date: May 8, 2025

(54) METHOD AND APPARATUS FOR A MOBILE HOTEL ROOM

(71) Applicant: Michael Vonderheid, Blyte, CA (US)

(72) Inventor: Michael Vonderheid, Blyte, CA (US)

(21) Appl. No.: 18/793,511

(22) Filed: Aug. 2, 2024

Related U.S. Application Data
(60) Provisional application No. 63/596,649, filed on Nov. 7, 2023.

(51) Int. Cl. B60P 3/38

(52) U.S. Cl. CPC B60P 3/38

(57) ABSTRACT

A mobile hotel room has a base structure secured to the ground, a framework secured to the base structure, and a plurality of living quarters secured to the framework. The framework is capable of rotation with respect to the base structure. The plurality of living quarters are capable of rotation with respect to the framework. The construction resembles a Ferris wheel. The plurality of living quarters are capable of accommodating various activities. One or more access tunnels may provide access to the plurality of living quarters from the hotel lobby.

### FIELD

The present disclosure generally relates to boutique hotels, and more particularly to a mobile hotel resembling a Ferris wheel.

### BACKGROUND

Short-term, paid lodging has existed throughout the world for a very long time. Inns existed throughout the medieval period, and hotels in more recent history. Luxury hotels began to spring up in the later part of the 19^{th} century, and often include luxury amenities, full-service accommodations, on-site restaurants, and the highest level of personalized service (e.g., concierge, room service, clothes ironing, and so forth).

Boutique hotels are smaller, independent, non-branded hotels that often contain unique facilities, environments, or experiences (e.g., custom decorated rooms). The notoriety of boutique hotels may come as a result of the hotel's historical significance, the delicatessen, due to popular culture, or because of the hotel's exclusive atmosphere.

Travelers across the world enjoy the opportunity to experience new and exciting places during their travels. The enjoyment they experience is in no small part due to the quality, security, and uniqueness of their stay at a hotel of their choosing.

Therefore, a need exists to provide new, unique, and exciting hotel facilities, environments, and experiences to maximize the enjoyment of travelers.

### SUMMARY

A hotel comprising a base structure secured to the ground, a framework secured to the base structure, the framework capable of rotation with respect to the base structure, and a plurality of living quarters secured to the framework, the plurality of living quarters capable of rotation with respect to the framework, the plurality of living quarters capable of accommodating various activities.

A hotel comprising a base structure secured to the ground, a framework secured to the base structure, the framework capable of rotation with respect to the base structure, a plurality of living quarters secured to the framework, the plurality of living quarters capable of rotation with respect to the framework, and one or more access tunnels extending at an elevation corresponding to a first position of the plurality of living quarters to provide access to the plurality of living quarters.

A method of assembling a hotel having a base structure, a framework, and a plurality of living quarters, the method comprising coupling the base structure to the ground, coupling the framework to the base structure, the framework capable of rotation with respect to the base structure, and coupling the plurality of living quarters to the framework, the plurality of living quarters capable of rotation with respect to the framework.

### BRIEF DESCRIPTION OF THE DRAWINGS

Various aspects and advantages will become apparent upon review of the following detailed description and upon reference to the drawings in which:

FIG. 1 illustrates a perspective view of a mobile hotel; and

FIG. 2 illustrates a perspective view of a mobile hotel.

### DETAILED DESCRIPTION

The following disclosure may include a method and apparatus for a mobile hotel. The mobile hotel may offer travelers with a new, unique, and exiting hotel experience. The mobile hotel may afford a unique environment. The mobile hotel may provide new facilities. The mobile hotel of the instant disclosure may be unlike any hotel experience heretofore known to travelers throughout the world, and may itself be a destination for eager travelers.

The mobile hotel may include fixed portions and moving portions. The mobile hotel may include a base structure secured to the ground. The mobile hotel may include a framework secured to the base structure. The framework may resemble a wheel (e.g., having spokes). The framework may rotate about a center point of the framework (e.g., at a confluence of the spokes). The framework may rotate with respect to the base structure.

The mobile hotel may include living quarters secured to (e.g., suspended from) the framework. Each living quarters may be secured to the framework at an attachment point. Living quarters may be secured at the outer perimeter of the framework. Living quarters may rotate with respect to the framework. Living quarters may remain horizontal. Living quarters may follow a circular path around the center point of the framework. Each living quarters may rotate about its respective attachment point at the same revolutionary rate as the rotation of the framework (e.g., in opposite rotational directions), such that the living quarters may remain level.

The mobile hotel may include a stationary structure. The stationary structure may be situated in close proximity to the moving portions. The stationary structure may include a first portion for housing the various amenities of the mobile hotel. The stationary structure may include a second portion for providing access to the moving portions of the mobile hotel. The second portion may include one or more tunnels and/or hallways providing access to the living quarters. The one or more hallways may provide access to the living quarters when the living quarters are in a first position (e.g., a low position).

Living quarters may be accessible for on-boarding and/or off-boarding of travelers in the first position. Living quarters may be inaccessible for on-boarding and/or off-boarding of travelers in any other position except for the first position (e.g., high and intermediate positions).

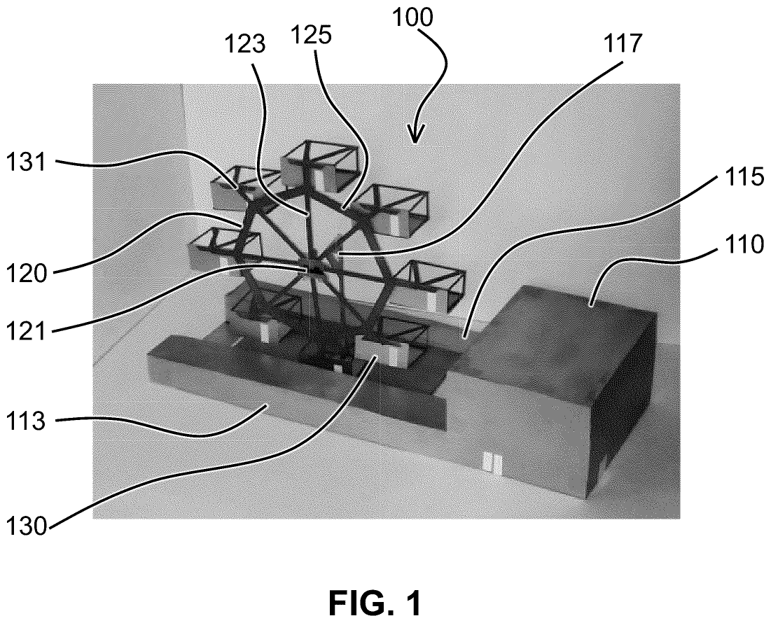

FIG. 1 illustrates a mobile hotel 100 for providing a unique lodging experience to travelers. Mobile hotel 100 may include a first stationary structure 110. First stationary structure 110 may include a lobby for receiving travelers (e.g., including a check-in and/or reservations area). First stationary structure 110 may include a restaurant. First stationary structure 110 may include a gift shop. First stationary structure 110 may include a sitting area. First stationary structure 110 may include a viewing area. First stationary structure 110 may include bathrooms.

First stationary structure 110 may be approximately cubic in shape. First stationary structure 110 may have square and/or rectangular walls. The dimensions of first stationary structure 110 may be about 60 feet long, about 48 feet wide, and/or about 35 feet in height. Nevertheless, this disclosure contemplates various shapes and/or dimensions for first stationary structure 110 to add to the novelty of the traveler's experience.

Mobile hotel 100 may include a second stationary structure 113 (e.g., a tunnel). Second stationary structure may be connected to first stationary structure (e.g., with interconnected interior spaces with or without a door). Second stationary structure may include a viewing area (e.g., open to the public). Second stationary structure may be approximately cubic in shape. Second stationary structure may have square and/or rectangular walls. The dimensions of second stationary structure may be about 116 feet long, 16 feet wide, and/or about 10 feet in height. Nevertheless, this disclosure contemplates various shapes and/or dimensions for second stationary structure 113 to add to the pleasure of the traveler's viewing experience.

Mobile hotel 100 may include a third stationary structure 115 (e.g., a tunnel). Third stationary structure may be connected to first stationary structure (e.g., with interconnected interior spaces with or without a door). Third stationary structure may include a viewing area (e.g., not open to the public). Third stationary structure may enable visitation of travelers. Third stationary structure may be approximately cubic in shape. Third stationary structure may have square and/or rectangular walls. The dimensions of third stationary structure may be about 116 feet long, 16 feet wide, and/or about 10 feet in height. Nevertheless, this disclosure contemplates various shapes and/or dimensions for third stationary structure 113 to add to the enjoyment of the traveler's visitation experience.

Mobile hotel 100 may include a fourth stationary structure 117 (e.g., a support structure). Fourth stationary structure 117 may be secured to a foundation, such as a concrete foundation (not shown), with sufficient mass and strength to retain fourth stationary structure 117 against movement while undergoing force loads.

Mobile hotel 100 may include a first mobile structure 120 (e.g., a framework). First mobile structure 120 may include a hub 121 secured to fourth stationary structure 117. First mobile structure 120 may include one or more radial elements 123 secured to hub 121. The one or more radial elements 123 may extend outwardly from hub 121 (e.g., resembling the spokes of a wheel). First mobile structure 120 may include one or more perimeter elements 125 (e.g., approximately forming a perimeter resembling a wheel).

Hub 121 may rotate with respect to fourth stationary structure 117. Hub 121, the one or more radial elements 123, and the one or more perimeter elements 125 may be securely coupled together to form the framework. The framework may rotate with respect to fourth stationary structure 117. Hub 121 may be positioned at a center point of the framework. The framework may resemble a Ferris wheel.

Mobile hotel 100 may include one or more secondary mobile structures 130 (e.g., one or more living quarters). The one or more secondary mobile structures 130 may be secured to and/or suspended from first mobile structure 120 (e.g., from a radial element 123 and/or from a perimeter element 125). The one or more secondary mobile structures 130 may be secured to and/or suspended at an outer perimeter of the framework.

Each of the one or more secondary mobile structures 130 may be secured and/or suspended from first mobile structure 120 at an attachment point 131, respectively. The one or more secondary mobile structures 130 may rotate with respect to first mobile structure 120. Each attachment point 131 may allow rotation of the one or more secondary mobile structures 130 with respect to first mobile structure 120. The rotation of the one or more secondary mobile structures 130 may allow the one or more secondary mobile structures 130 to stay level and/or horizontal during the rotation of first mobile structure 120.

First mobile structure 120 may rotate with a specified cycle speed, measured as the rotational speed of a full 360 degree rotation per unit time. The cycle speed may be relatively slow (e.g., between about 1 minute per cycle and about 20 minutes per cycle) due to the large mass of the system components and due to the nature of use of the system for carrying people. First mobile structure 120 may rotate in a rotational direction (e.g., clockwise).

Each of the one or more secondary mobile structures 130 may rotate with a specified cycle speed (e.g., equal to the cycle speed of first mobile structure 120). Each of the one or more secondary mobile structures 130 may rotate in a rotational direction (e.g., counter-clockwise and/or oppositely of the rotational direction of first mobile structure 120). The one or more secondary mobile structures 130 may follow an approximate circular path of travel as first mobile structure 120 rotates. Where the one or more secondary mobile structures 130 rotate oppositely to first mobile structure 120 at the same cycle speed, the one or more secondary mobile structures 130 may appear as though they are not rotating in space (e.g., maintaining a fixed position rotationally while moving along a curved and/or circular path of travel).

Each of the one or more secondary mobile structures 130 may be located in close proximity to second stationary structure 113 (e.g., when at a discrete position along a path of travel). Close proximity of each secondary mobile structure 130 to second stationary structure 113 (e.g., in a first position) may allow on-boarding and/or off-boarding of travelers, guests, hotel staff, maintenance personnel, and so forth. Each of the one or more secondary mobile structures 130 may be located in close proximity to third stationary structure 115 (e.g., when at a discrete position along a path of travel). Close proximity of each secondary mobile structure 130 to third stationary structure 115 (e.g., in a first position) may allow on-boarding and/or off-boarding of travelers, guests, hotel staff, maintenance personnel, and so forth. Each of the one or more secondary mobile structures 130 may be located in close proximity to second stationary structure 113 and third stationary structure 115 simultaneously (e.g., where second stationary structure 113 and third stationary structure 115 are approximately level and/or located at the same height). Each of the one or more secondary mobile structures 130 may be located in close proximity to second stationary structure 113 and third stationary structure 115 at different times (e.g., where second stationary structure 113 and third stationary structure 115 are not level and/or located at different heights).

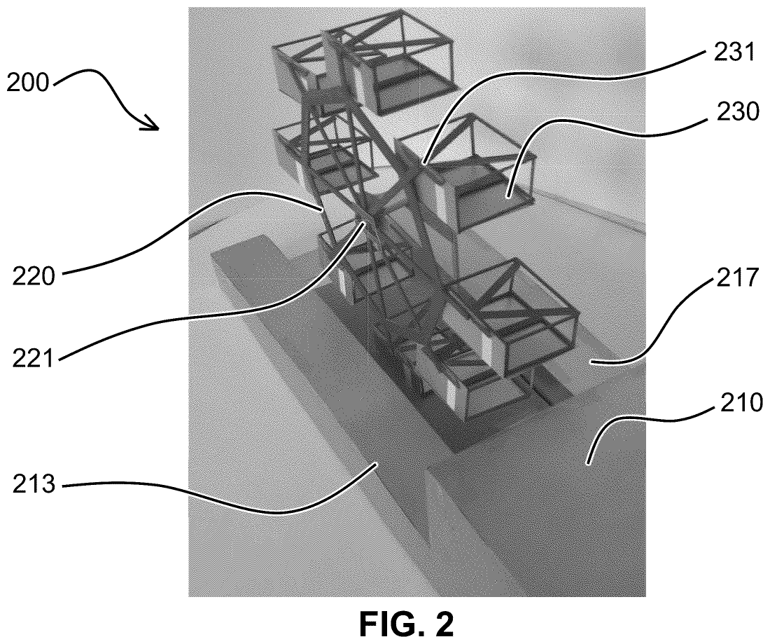

FIG. 2 illustrates a mobile hotel 200 for providing an original lodging experience to travelers. Mobile hotel 200 may include a primary building (e.g., a first stationary structure 210), one or more secondary buildings (e.g., a first tunnel 213 and/or a second tunnel 217), and one or more moving constructions (e.g., a framework 220 and/or one or more living quarters 230).

The secondary buildings may extend from the primary building to enable access to and/or viewing of the one or more moving constructions (e.g., extending along either or both sides of the one or more moving constructions). The one or more moving constructions may include a framework 220 (e.g., resembling a Ferris wheel). Framework 220 may be capable of rotation about a center point 221. Framework 220 may have an outer perimeter at which are attached one or more living quarters 230. Living quarters 230 may be secured to framework 220 incrementally around the outer perimeter of framework 220 (e.g., spaced evenly).

Framework 220 may rotate about the center point 221, such that the outer perimeter of framework 220 may moving along a circular path of travel. Living quarters 230 may be attached to framework 220 at an attachment point 231 (e.g., enabling rotation about an attachment axis extending through the attachment point 231). Each living quarter 230 may have its own attachment point 231 (e.g., and its own attachment axis). Living quarters 230 may rotate with respect to framework 220 (e.g., rotating with an equal cycle speed and/or rotating in an opposite rotational direction). Living quarters 230 may rotate along a path of travel determined by the rotation of living quarters 230 and framework 220. Living quarters 230 may be spaced apart enough to prevent collision of adjacent living quarters 230.

Framework 220 may accommodate any number of living quarters 230 (e.g., 1, 2, 3, 4, 5, 6, 7, 8, 9, 10, or more). Living quarters 230 may be evenly distributed around the outer perimeter of framework 220 so that the weight of all of living quarters 230 attached to framework 220 are approximately balanced around the center point 221. Balancing the weight of the one or more living quarters 230 around the center point 221 may serve to minimize the force required to rotate the framework 220 during use of the living quarters 230 by travelers.

Living quarter 230 may include one or more doors (e.g., for accessing the one or more secondary buildings), one or more windows (e.g., for providing a viewing experience for travelers), as well as the normal features of a hotel room (e.g., kitchenette, bed, bathroom, furnishings, etc.). Living quarters 230 may include a power system (e.g., including electrical wiring, switches, and other electrical components), a fresh-water system (e.g., including a pressurized water source and/or piping to all appliances), and/or a gray-water system (e.g., including run-off piping from all appliances and/or a water retainer). Living quarters 230 may include an enclosed porch area (e.g., open to the air, but preventing exiting the living quarters 230 through the porch area).

Living quarters 230 may follow a path of travel during the rotation of framework 220 and/or the rotation of living quarters 230. A first living quarters 230 may be positioned at the bottom of framework 220 (e.g., between the secondary buildings and/or at ground level), corresponding to a first position. The framework 220 may move (e.g., rotate) until a second living quarters 230 is positioned at the bottom of framework 220. Now the first living quarters 220 is in a second position (e.g., an elevated and/or intermediate position) and the second living quarters 220 is in the first position. This process may be repeated for each additional living quarters 230, such that all living quarters may be moved into or out of the first position and/or any other position along the path of travel.

As an example, and without limitation, the framework 220 may have a total of 8 living quarters 230 spaced around the outer perimeter of framework 220, though greater or fewer living quarters are contemplated by this disclosure. The cycle speed of framework 220 may be one full wheel rotation every sixty (60) minutes (e.g., 7.5 minutes to rotate from a living quarters 230 in the first position to the next living quarters 230 arriving in the first position), though faster or slower cycle speeds are contemplated by this disclosure. Living quarters 230 may remain in the first position for seven (7) minutes (e.g., adding 56 minutes of stop time for the 8 living quarters 230), though longer or shorter stop times are contemplated by this disclosure. In this example, each living quarters 230 may arrive in the first position (or any other elevated and/or intermediate position) every 116 minutes.

A wheel rotation time (WRT) may be the time between an arrival of a living quarter 230 in the first position and the next subsequent arrival of the same living quarter 230 in the first position (e.g., include the time in which the living quarters 230 are moving and the time in which the living quarters 230 are stationary). In the example above, the WRT may have been 116 minutes, though longer and shorter wheel rotation times are contemplated by this disclosure.

When a living quarter 230 is departing the first position, the one or more doors that permit access to the living quarter 230 may be locked automatically. The one or more doors may remain locked until the living quarter returns to the first position. Visitors who have paid for lodging in the living quarters 230 may be required to wait until the living quarters 230 returns to the first position before entering or exiting the living quarters 230. In case of emergency, a living quarter 230 may proceed directly to the first position to allow emergency personnel to access the living quarter 230, or to allow visitors to exit the living quarter 230. It may also be possible to increase the cycle speed of framework 220 to enable a living quarter 230 to arrive in the first position more quickly for emergency access. It may also be possible to reverse the rotational direction of framework 220 to enable a living quarter 230 to arrive in the first position more quickly for emergency access.

While the movement of framework 220 has been described as following a specified routine and/or schedule, with scheduled access to living quarters 230, this disclosure also contemplates irregular movements. Framework 220 may move at a specified cycle speed when no access is needed to the living quarters 230. A visitor who desires to enter or exit a living quarter 230 may press a button (e.g., in the living quarter 230 and/or in a tunnel) to indicate their desire to enter or exit the living quarter 230 and/or to “call” the living quarter 230 into the first position. It may also be necessary to indicate which living quarter 230 it is desired to have delivered into the first position. Framework 220 may continue to rotate until the living quarter 230 is delivered into the first position to allow access to or from the living quarter 230. It is therefore contemplated that the cycle time may be much faster than previously indicated (e.g., 1 full rotation every 1, 2, 3, 4, 5, or more minutes). Framework 220 may rotate in an opposite direction until the living quarter 230 is delivered into the first position to allow access to or from the living quarter 230 more quickly.

The power system, fresh-water system, and gray-water systems may be replenished when the living quarter 230 is in the first position. Arriving in the first position may facilitate a physical contact between conduit or piping to enable replenishment. Arriving in the first position may bring electrical conduit into contact to enable power to be transferred into a power bank located on the living quarter 230. The power bank may provide power for electrical components and/or personal electronic devices when the living quarter 230 is not in the first position. Attachment point 231 may include electrical contacts to allow power to be provided to the power system of living quarters 230 (e.g., throughout the path of travel of living quarters 230 as framework 220 rotates). In this arrangement no power bank may be needed, or a power bank may be provided only as a failsafe.

Arriving in the first position may bring fresh-water piping into contact to enable potable water to be transferred into a water reservoir located on the living quarter 230. The water reservoir may provide potable water for plumbing appliances (e.g., sinks, showers, tubs) when the living quarter 230 is not in the first position. Water reservoir may be pressurized by a pump located downstream of the water reservoir (e.g., powered by the electrical system). Water reservoir may be pressurized by gravity (e.g., positioned above and/or on top of the living quarter 230).

Arriving in the first position may bring gray-water piping into contact to enable gray water (e.g., sewage) to be transferred from a sewage reservoir located on the living quarters 230 into a graywater system of the hotel. The sewage reservoir may receive used water and/or refuse from plumbing appliances (e.g., sinks, showers, tubs) when the living quarter 230 is not in the first position. Sewage reservoir may be pressurized by a pump located downstream of the sewage reservoir (e.g., powered by the electrical system) to pump and/or chop used water and refuse into the hotel's gray-water system. Sewage reservoir may be pressurized by gravity (e.g., positioned below living quarter 230 and/or above the connection to the hotel's gray-water system).

While it has not been described explicitly above, it is understood and contemplated by this disclosure that the fresh-water and gray-water systems may require the use of various pumps and/or valves to control when transfer of fluids occurs (e.g., only in the first position). Valves and/or pumps may be present in the systems in and/or on the living quarters 230, and valves and/or pumps may be present on the hotel's corresponding systems. Further, some moveable elements may enable movement to engage corresponding components of the hotel's systems with the systems in and/or on the living quarters 230 (e.g., an extendable pipe may be moved from the hotel's system to engage the system of the living quarters 230). The movement of piping and/or conduit may be facilitated by motors, solenoids, actuators, or other known means for automating such movements (e.g., without the need for a human operator to perform such couplings). It is also contemplated that electrical power may be transferred to the living quarters 230 wirelessly (e.g., in the first position and/or throughout the movement and/or wheel rotation of framework 220).

Living quarters 230 may be equipped as sleeping quarters (e.g., having one or more beds and corresponding furnishings). Living quarters 230 may be equipped as conference rooms (e.g., having seating around a large table or series of tables). Living quarters 230 may be equipped as lecture halls (e.g., having a stage and/or podium, and rows and/or columns of seating). Living quarters 230 may be equipped as a restaurant (e.g., having tables and chairs, a bar, and/or a performance stage). Living quarters 230 may be equipped as a lounge (e.g., having armchairs and couches, a bar, and one or more televisions for displaying sports games or other content). Living quarters 230 may be equipped as a club space (e.g., having a bar, limited seating, a disc jockey apparatus, and an open floor for dancing). Living quarters 230 may be equipped as a recreational space (e.g., having the capability of being rented and/or used by any group for an activity hosted by that group, whatever the group's needs may be and/or using equipment provided by the group). Living quarters 230 may be equipped with any combination of the above features. Living quarters 230 may accommodate various activities (e.g., a multi-purpose space). Living quarters may accommodate small or large quantities of people (e.g., between 1 and 100 people).

Living quarters 230 may be equipped with means for ventilation (e.g., fans, air conditioners, heaters). Living quarters 230 may be equipped with any number of windows (e.g., an entire wall may be formed entirely by windows). The ceiling may be at least partially formed by windows. Windows may be coverable by one or more window coverings (e.g., blinds, roller shades, etc.). Room service and room cleaning services may be provided for each living quarters 230 when in the first position. A clock may be provided in each living quarters 230 to indicate when the living quarters 230 will arrive back in the first position. A visitor may be able to indicate a “do not disturb” condition in which case the living quarters 230 may not return to the first position, or if so, the one or more doors may remain locked. An audible system may notify visitors (e.g., via tones, or prerecorded messages) of travel conditions of that living quarters 230. The audible system may be silent when the “do not disturb” condition is activated.

In one embodiment the mobile hotel room may include a fully functional hotel room located on a fully functional Ferris Wheel.

Other aspects will be apparent to those skilled in the art from consideration of the specification and practice disclosed herein. It is intended, therefore, that the specification and illustrated embodiments be considered as examples only.

What is claimed is:

1. A hotel, comprising:
a base structure secured to the ground;
a framework secured to the base structure, the framework capable of rotation with respect to the base structure; and
a plurality of living quarters secured to the framework, the plurality of living quarters capable of rotation with respect to the framework, the plurality of living quarters capable of accommodating various activities.

2. The hotel of claim 1, further including one or more access tunnels extending at an elevation corresponding to a first position of the plurality of living quarters to provide access to the plurality of living quarters.

3. A hotel, comprising:
a base structure secured to the ground;
a framework secured to the base structure, the framework capable of rotation with respect to the base structure;
a plurality of living quarters secured to the framework, the plurality of living quarters capable of rotation with respect to the framework; and
one or more access tunnels extending at an elevation corresponding to a first position of the plurality of living quarters to provide access to the plurality of living quarters.

4. The hotel of claim 3, wherein the plurality of living quarters are capable of accommodating various activities.

5. A method of assembling a hotel having a base structure, a framework, and a plurality of living quarters, the method comprising:
coupling the base structure to the ground;
coupling the framework to the base structure, the framework capable of rotation with respect to the base structure; and
coupling the plurality of living quarters to the framework, the plurality of living quarters capable of rotation with respect to the framework.

6. The hotel of claim 5, wherein the plurality of living quarters are capable of accommodating various activities.

7. The hotel of claim 5, further including one or more access tunnels extending at an elevation corresponding to a first position of the plurality of living quarters to provide access to the plurality of living quarters.
